(19) United States
(12) Patent Application Publication
(10) Pub. No.: US 2016/0026605 A1
(43) Pub. Date: Jan. 28, 2016

(54) REGISTRATIONLESS TRANSMIT ONLOAD RDMA

(71) Applicant: EMULEX CORPORATION, Costa Mesa, CA (US)

(72) Inventors: Parav K. Pandit, Bangalore (IN); Masoodur Rahman, Austin, TX (US)

(21) Appl. No.: 14/523,840

(22) Filed: Oct. 24, 2014

Related U.S. Application Data
(60) Provisional application No. 62/030,057, filed on Jul. 28, 2014.

(51) Int. Cl. G06F 15/17; G06F 15/167

(52) U.S. Cl. CPC G06F 15/17; G06F 15/167

(57) ABSTRACT

An RDMA transceiving system in which an operating system of the RDMA transceiving system performs a first sub-process of an RDMA transmission, and an RDMA network communication adapter device of the RDMA transceiving system performs a second sub-process of the RDMA transmission responsive to RDMA transmission information provided by the operating system. The operating system performs the first sub-process responsive to a request that includes a virtual address corresponding to a buffer to be used for the RDMA transmission, and the operating system translates the virtual address into a physical address. The RDMA network communication adapter device performs an RDMA access responsive to the physical address.

### CROSS REFERENCE

This patent application claims the benefit of U.S. Provisional Patent Application No. 62/030,057 entitled REGISTRATIONLESS TRANSMIT ONLOAD RDMA filed on Jul. 28, 2014 by inventors Parav K. Pandit, and Masoodur Rahman.

### FIELD

The present disclosure relates to remote direct memory access (RDMA).

### BACKGROUND

Direct memory access (DMA) is a feature of computers that allows certain hardware subsystems within the computer to access system memory independently of the central processing unit (CPU). Remote direct memory access (RDMA) is a direct memory access (DMA) of a memory of a remote computer, typically without involving either computer's operating system.

For example, a network communication adapter device of a first computer can use DMA to read data in a user-specified buffer in a main memory of the first computer and transmit the data as a self-contained message across a network to a receiving network communication adapter device of a second computer. The receiving network communication adapter device can use DMA to place the data into a user-specified buffer of a main memory of the second computer. This remote DMA process can occur without intermediary copying and without involvement of CPUs of the first computer and the second computer.

### SUMMARY

Embodiments disclosed herein are summarized by the claims that follow below. However, this brief summary is being provided so that the nature of this disclosure may be understood quickly.

There is a need for more scalable RDMA systems that consume less memory resources, reduce memory registration latency, and that can incorporate commodity hardware. This need is addressed by an RDMA transceiving system in which an operating system of the RDMA transceiving system performs a first sub-process of an RDMA transmission, and an RDMA network communication adapter device performs a second sub-process of the RDMA transmission responsive to RDMA transmission information provided by the operating system. The operating system performs the first sub-process responsive to a request that includes a virtual address corresponding to a buffer to be used for the RDMA transmission, and the operating system translates the virtual address into a physical address. The RDMA network communication adapter device performs an RDMA access responsive to the physical address.

Because the operating system can perform virtual address translation, the operating system can perform the first sub-process without performing an RDMA memory registration, and without consuming memory resources beforehand. In other words, because the operating system can perform virtual address translation, the operating system can perform the first sub-process with un-locked memory pages, without a virtual address translation entry, and without involving the RDMA network communication adapter.

Because the RDMA network communication adapter device receives a physical address, it does not need to store a virtual address translation entry. Moreover, because at least a portion of the RDMA process is performed by the operating system, commodity adapter devices with more limited processing and memory resources can be used in the RDMA transceiving system.

In an example embodiment, RDMA transmission is provided in which a processor of an information processing apparatus uses an operating system to perform at least a first sub-process of the RDMA transmission, responsive to a request for an RDMA transmission. The processor provides RDMA transmission information to an RDMA network communication adapter device of the apparatus, and the network communication adapter device performs at least a second sub-process of the RDMA transmission responsive to the RDMA transmission information. The request for the RDMA transmission includes at least a virtual address corresponding to a buffer to be used for the RDMA transmission. The operating system translates the virtual address into a corresponding physical address of a main memory of the apparatus. The RDMA transmission information includes the translated physical address, and the network communication adapter device performs an RDMA access responsive to the physical address.

According to an aspect, the RDMA transmission is performed without performing an INFINIBAND memory region registration, the RDMA network communication adapter device does not store a virtual address translation table, the RDMA network communication adapter device does not translate the virtual address into the physical address, and pages corresponding to the buffer are not locked prior to the RDMA transmission.

According to some aspects, the operating system receives the request for the RDMA transmission via an application work request queue that resides in an address space of the main memory that is accessible by user-space and kernel-space processes. The operating system provides the RDMA transmission information to the network communication adapter device via a kernel work request queue that resides in an address space of the main memory that is accessible by kernel-space processes and processes performed by the network communication adapter device. The network communication adapter device retrieves the RDMA transmission information from the kernel work request queue and performs the second sub-process responsive to the RDMA transmission information, such that the second sub-process is offloaded to the network communication adapter device. The application work request queue resides in un-locked pages of the main memory, whereas the kernel work request queue resides in locked pages of the main memory. A number of kernel work request queues resident in the main memory is less than a number of application work request queues resident in the main memory.

According to further aspects, the RDMA network communication adapter device processes RDMA transmissions received from a remote device, and the operating system processes RDMA Read responses. The operating system maintains a state of the RDMA transmission. The state of the RDMA transmission includes at least one of signaling journals and ACK timers. The first sub-process includes at least one of journaling of signaled work requests, management of ACK timers, management of NAK timers, and performing protection domain checks. The second sub-process includes at least one of message segmentation, ICRC calculation, and ICRC validation. The buffer includes at least one of a send buffer, a write buffer, a read buffer and a receive buffer in the application address space.

### BRIEF DESCRIPTION OF THE DRAWINGS

The following is a brief description of the drawings, in which like reference numbers may indicate similar elements.

FIG. 1A is a block diagram depicting an exemplary computer networking system with a data center network system having an RDMA communication network, according to an example embodiment.

FIG. 1B is a diagram depicting an exemplary RDMA transceiving system, according to an example embodiment.

FIG. 2 is a diagram depicting an RDMA transmission, according to an example embodiment.

FIG. 3 is a diagram depicting an RDMA transmission for an RDMA Read operation, according to an example embodiment.

FIG. 4 is a diagram depicting a processing of a read response for an RDMA Read operation, according to an example embodiment.

FIG. 5 is a diagram depicting a processing of a read response for an RDMA Read operation, according to an example embodiment.

FIG. 6 is an architecture diagram of a RDMA transceiving system, according to an example embodiment.

FIG. 7 is an architecture diagram of a network communication adapter device, according to an example embodiment.

FIG. 8 is a diagram depicting an exemplary structure of an application work request element, according to an example embodiment.

FIG. 9 is a diagram depicting an exemplary structure of a kernel work request element, according to an example embodiment.

FIG. 10 is a diagram depicting an exemplary structure of an RDMA transmission entry, according to an example embodiment.

### DETAILED DESCRIPTION

In the following detailed description, numerous specific details are set forth in order to provide a thorough understanding. However, it will be obvious to one skilled in the art that the embodiments may be practiced without these specific details. In other instances well known methods, procedures, and components have not been described in detail so as not to unnecessarily obscure aspects of the embodiments described herein.

Methods, non-transitory machine-readable storage media, apparatuses, and systems are disclosed that provide remote direct memory access (RDMA).

One potential performance limitation of typical RDMA systems relates to memory registration.

In typical RDMA systems software transport layer interfaces define RDMA verbs, the interface to an RDMA enabled network interface controller, that can be used by user-space applications to invoke RDMA functionality. The RDMA verbs typically provide access to RDMA queuing and memory management resources, as well as underlying network layers.

RDMA processing is typically offloaded onto the network communication adapter devices by having them perform the processes that correspond to the RDMA verbs. However, fully offloading RDMA processing onto the network communication adapter devices may limit the scalability of the RDMA system. As a number of RDMA transactions increase within the RDMA system, additional main memory and adapter device memory resources may be consumed.

More specifically, in invoking RDMA verbs, user-space applications typically specify virtual addresses corresponding to the regions of main memory that are to be accessed. However, execution of RDMA operations typically requires physical addresses of the memory regions to be accessed, and a network communication adapter device typically cannot translate virtual addresses into physical addresses. Therefore, typical RDMA systems provide the network communication adapter device with physical addresses to be used in future RDMA operations prior to performing such operations. In many systems, a processor of the computer performs virtual address translation by using an operating system (OS) executed by the processor. Unlike typical network communication adapter devices, the operating system is constructed to translate virtual addresses into physical addresses.

In accordance with the RDMA protocol, these physical addresses are typically provided to the network communication adapter device during an RDMA memory registration process. During an RDMA memory registration process, the operating system of the computer generates virtual address translation entries for the registered virtual addresses, and locks pages in main memory that correspond to the virtual addresses. The operating system locks the pages to avoid page out during RDMA operations. The network communication adapter device of the computer stores the virtual address translation entries in a memory of the network communication adapter device. The virtual address translation entries enable the network communication adapter device to translate virtual addresses received from the user-space application into physical addresses which can be used in RDMA operations.

The memory registration process can be a relatively slow process, often taking twenty microseconds or more to complete. Moreover, an amount of memory locking (pinning) can grow significantly as RDMA transactions increase. At the same time, many RDMA connections might be inactive for a long duration of time, and during this time, registered memory pages are locked in main memory and cannot be paged out. As a result, less main memory is available. Furthermore, virtual address translation entries consume additional adapter device memory resources as RDMA transactions increase.

Due to the RDMA programming model, a device that transmits an RDMA request to a remote device is typically required to perform memory registration for any RDMA transmission, including requests for SEND, RDMA Write, and RDMA Read operations.

However, for an RDMA transmission initiated by a user-space application of an RDMA-enabled device, there is often no need to perform virtual memory registration if virtual address translation and main memory page locking can be performed during performance of the processes that correspond to the RDMA verbs. Because the operating system can perform virtual memory translation and page locking, memory registration can be reduced if the operating system performs at least a portion of the processing for the RDMA verbs. In other words, by onloading at least a portion of RDMA verbs processing onto the operating system, memory registration can be reduced.

Another potential performance limitation of typical RDMA systems relates to locking pages for user-space queues holding RDMA work requests.

User-space applications typically invoke RDMA functionality by using an RDMA verb to submit application work requests to application work request queues that reside in main memory, and that are accessible by the network communication adapter device. These application work request queues typically include state information related to RDMA functionality. The application work requests specify an RDMA operation (e.g., SEND, RDMA Read, RDMA Write) and the network communication adapter device retrieves application work requests from the application work request queues and performs a process corresponding to the RDMA operation specified in the application work request. For example, if the application work request specifies an RDMA Read operation, then the network communication adapter device performs an RDMA Read process. Since the network communication adapter device ordinarily accesses the main memory by using physical addresses, the operating system locks the pages corresponding to the application work request queues to avoid page out of the application work request queues and to ensure that the network communication adapter device can access the application work requests.

In large computer clusters, there can be thousands of application work request queues used by a given computer, and locking the pages corresponding to all of these application work request queues can consume gigabytes of main memory. Moreover, many of these application work request queues may not be active at a given time, and thus locking of all of the application work request queue pages can be wasteful.

However, the number of locked pages can be reduced by onloading at least a portion of RDMA functionality onto a processor that executes the operating system of the computer, such that this processor retrieves work requests from the work request queues and performs at least part of a process corresponding to the RDMA operation specified in the work request. Because the processor can use the operating system to access the main memory by using virtual addresses, the processor can retrieve application work requests from the application work request queues even if the corresponding pages are paged out. Accordingly, RDMA processing performed by the computer processor can be performed without locking the pages of the application work request queues.

The RDMA processing performed by the computer processor can include state-dependent processing such as, for example, journaling of signaled work requests to ensure that the correct number of completions is returned for signaled work requests, managing ACK timers, and managing negative acknowledgement (NAK) timers.

To reduce load on processors of the computer without significantly increasing main memory consumption, state-independent RDMA processing can be offloaded onto the network communication adapter device by having the processors of the computer place kernel work requests on kernel work request queues that are accessible by the network communication adapter device. Such state-independent RDMA processing does not depend on stateful information (e.g., signaling journals, ACK timers, and the like), and can include, for example, message segmentation, ICRC calculation, ICRC validation, and the like.

For example, in processing an application work request retrieved from user-space application work request queue, the processor of the computer can generate a kernel work request for offloading state-independent processing onto the network communication adapter device. The processor places the kernel work request for the network communication adapter device onto a kernel work request queue that resides in main memory and is accessible by the network communication adapter device, and the network communication adapter device can retrieve the kernel work request from the kernel work request queue and perform state-independent RDMA processing associated with the kernel work request.

Since the kernel work request queues do not depend on a state of the RDMA transmission, kernel work requests generated from user-space application work requests received from multiple application work request queues can be posted to the same kernel work request queue. In other words, in cases in which the main memory stores thousands of application work request queues, the main memory can include a single kernel work request queue. However, to improve performance the number of kernel work request queues can be based on a number of processors of the computer.

Therefore, unlike a fully offloaded RDMA system, a partially offloaded RDMA system can involve use of a smaller number of work request queues for providing work requests to the network communication adapter device.

Although the operating system locks the pages corresponding to the kernel work request queues to avoid page out, since the number of kernel work request queues is smaller than the number of application work request queues, the number of locked pages can be reduced as compared with a system in which pages of all application work request queues are locked.

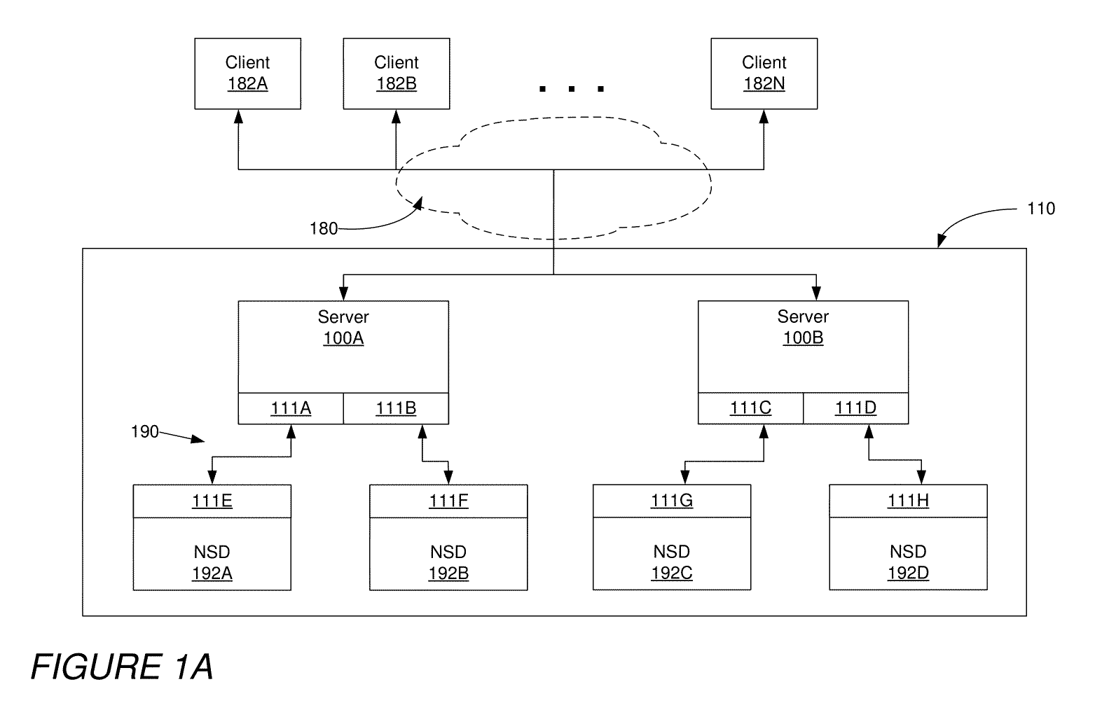

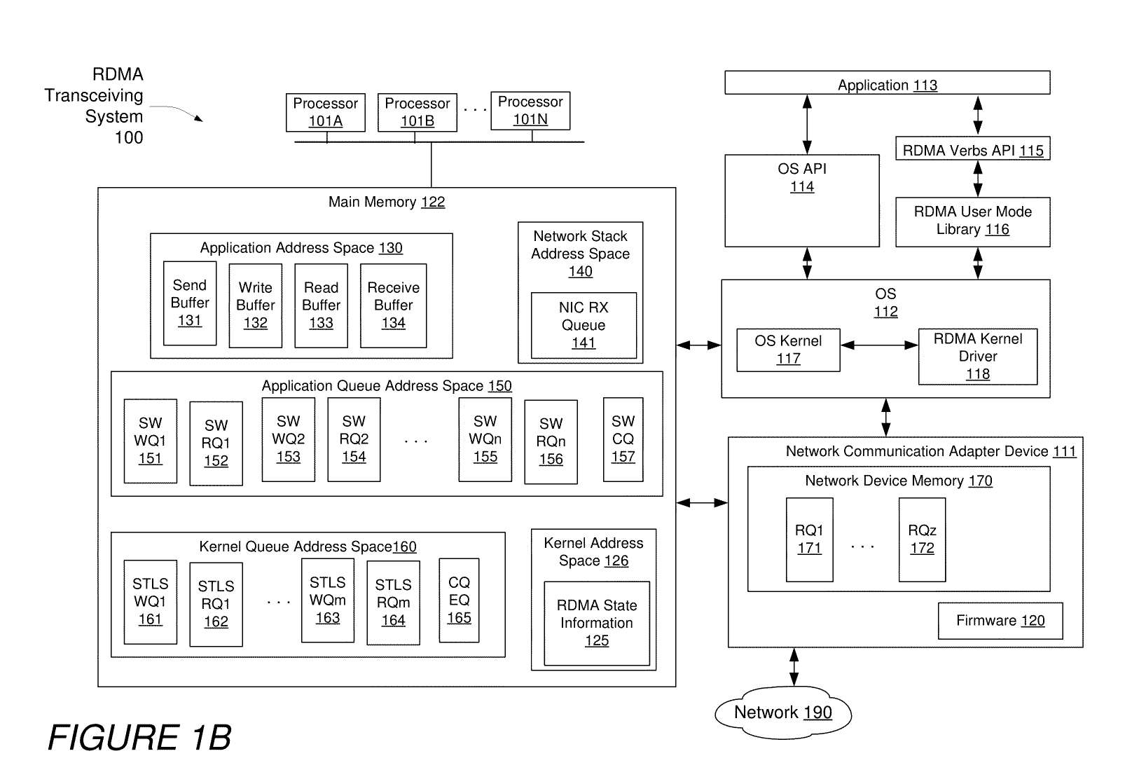

Referring now to FIG. 1A, a block diagram illustrates an exemplary computer networking system with a data center network system 110 having an RDMA communication network 190. One or more remote client computers 182A-182N may be coupled in communication with the one or more servers 100A-100B of the data center network system 110 by a wide area network (WAN) 180, such as the world wide web (WWW) or internet.

The data center network system 110 includes one or more server devices 100A-100B and one or more network storage devices (NSD) 192A-192D coupled in communication together by the RDMA communication network 190. RDMA message packets are communicated over wires or cables of the RDMA communication network 190 the one or more server devices 100A-100B and the one or more network storage devices (NSD) 192A-192D. To support the communication of RDMA message packets, the one or more servers 100A-100B may each include one or more RDMA network interface controllers (RNICs) 111A-111B,111C-111D (sometimes referred to as RDMA host channel adapters), also referred to herein as network communication adapter device(s) 111.

To support the communication of RDMA message packets, each of the one or more network storage devices (NSD) 192A-192D includes at least one RDMA network interface controller (RNIC) 111E-111H, respectively. Each of the one or more network storage devices (NSD) 192A-192D includes a storage capacity of one or more storage devices (e.g., hard disk drive, solid state drive, optical drive) that can store data. The data stored in the storage devices of each of the one or more network storage devices (NSD) 192A-192D may be accessed by RDMA aware software applications, such as a database application. A client computer may optionally include an RDMA network interface controller (not shown in FIG. 1A) and execute RDMA aware software applications to communicate RDMA message packets with the network storage devices 192A-192D.

Referring now to FIG. 1B, a block diagram illustrates an exemplary RDMA transmitting and/or receiving (transceiving) system 100 that can be instantiated as the server devices 100A-100B of the data center network 110. In the example embodiment, the RDMA transceiving system 100 is a server device. In some embodiments, the RDMA transceiving system 100 can be any other suitable type of RDMA transceiving system, such as, for example, a client device, a network device, a storage device, a mobile device, a smart appliance, a wearable device, a medical device, a sensor device, a vehicle, and the like.

The RDMA transceiving system 100 is an exemplary RDMA-enabled information processing apparatus that is configured for RDMA communication to transmit and/or receive RDMA message packets. The RDMA transceiving system 100 includes a plurality of processors 101A-101N, a network communication adapter device 111, and a main memory 122 coupled together. One of the processors 101A-101N is designated a master processor to execute instructions of an operating system (OS) 112, an application 113, an Operating System API 114, an RDMA Verbs API 115, and an RDMA user-mode library 116. The OS 112 includes software instructions of an OS kernel 117 and an RDMA kernel driver 118.

The main memory 122 includes an application address space 130, a network stack address space 140, an application queue address space 150, and a kernel queue address space 160. The application address space 130 is accessible by user-space processes. The network stack address space 140 is accessible by kernel-space processes. The application queue address space 150 is accessible by user-space and kernel-space processes. The kernel queue address space 160 is accessible by kernel-space processes and processes performed by the network communication adapter device 111.

The application address space 130 includes buffers 131 to 134 used by the application 113 for RDMA transactions. The buffers include a send buffer 131, a write buffer 132, a read buffer 133 and a receive buffer 134.

The network stack address space 140 includes a network interface controller (NIC) receive queue 141.

The application RDMA queue address space 150 includes application RDMA queues 151 to 157. The RDMA queues 151 and 152 are a send queue (SQ) and a receive queue (RQ), respectively, of a first queue pair. The RDMA queues 153 and 154 are a send queue and a receive queue, respectively, of a second queue pair. The RDMA queues 155 and 156 are a send queue and a receive queue, respectively, of an additional queue pair. The RDMA queue 157 is a completion queue (CP). The application 113 creates these RDMA queues in the application queue address space 150 by using the RDMA verbs API 115 and the RDMA user mode library 116. Once they are created, these RDMA queues are accessible by the RDMA user-mode library 116 and the RDMA kernel driver 118. The application RDMA queues 151 to 157 reside in un-locked (unpinned) memory pages.

In an example implementation, the application RDMA queues 151 to 156 are stateful because the RDMA transceiving system 100 maintains a state of the queue pairs that include the queues 151 to 156 (e.g., in the state information 125). The RDMA transceiving system 100 also maintains a state in connection with processing of work requests stored in send queues (e.g., send queues 151, 153 and 155) of the application queue pairs.

The kernel RDMA queue address space 160 includes kernel RDMA queues 161 to 165. The RDMA queues 161 and 162 are a send queue and a receive queue, respectively, of a first queue pair. The RDMA queues 163 and 164 are a send queue and a receive queue, respectively, of an additional queue pair. The RDMA queue 165 is a completion queue. The RDMA kernel driver 118 creates the queues in the kernel queue address space 160 during initialization of RDMA services by the operating system 112. Once created, the RDMA kernel driver 118 locks the memory pages corresponding to the kernel RDMA queues 161 to 165. The RDMA kernel queues 161 to 165 are accessible by the RDMA kernel driver 118 and the network communication adapter device 111.

In the example implementation, the kernel RDMA queues 161 to 164 are stateless because the RDMA transceiving system 100 does not maintain a state of the queue pairs that include the RDMA queues 161 to 164. The RDMA transceiving system 100 does not maintain a state in connection with processing of work requests stored in kernel RDMA send queues (e.g., RDMA send queues 161 and 163) of the kernel queue pairs.

As shown in FIG. 1B, there are n application queue pairs in the application queue address space 150 and m kernel queue pairs in the kernel queue address space 160. The number n corresponds to the number of queue pairs created by the application 113. The number m corresponds to the number of processors 101A-101N. In the example embodiment of FIG. 1B, the number of application queue pairs is greater than the number of kernel queue pairs. In some implementations, there may be only one kernel queue pair. In some implementations, the number of application queue pairs is the same as the number of kernel queue pairs, but the kernel queue pairs have a smaller work request capacity than the application queue pairs. In other words, in some implementations, the kernel queue pairs store much less work requests than the application queue pairs.

The network communication adapter device 111 includes a memory 170 and firmware 120. The network device memory 170 includes offloaded RDMA receive queues 171 and 172. The number of offloaded RDMA receive queues included in the memory 170 corresponds to a number of application receive queues created by the application 113.

In the example implementation, the RDMA verbs API 115, the RDMA user-mode library 116, the RDMA kernel driver 118, and the network device firmware 120 provide RDMA functionality in accordance with the INIFNIBAND Architecture (IBA) specification (e.g., INIFNIBAND Architecture Specification Volume 1, Release 1.2.1 and Supplement to INIFNIBAND Architecture Specification Volume 1, Release 1.2.1—RoCE Annex A16, which are incorporated by reference herein). In the example implementation, the RDMA verbs provided by the RDMA Verbs API 115 are RDMA verbs that are defined in the INIFNIBAND Architecture (IBA) specification. RDMA verbs include the following verbs which are described herein: Create Queue Pair, and Post Send Request.

During an RDMA transmission, the RDMA kernel driver 118 maintains a state of the RDMA transmission in the memory 122. The state information 125 includes connection information for the RDMA transmission, which specifies the connection between an RDMA queue pair on the RDMA transceiving system 100 and an RDMA queue pair of a remote system (not shown). In some implementations, the connection information includes an RDMA queue pair ID for the remote RDMA queue pair, and a corresponding IP address, RDMA partition key and RDMA remote key for the remote RDMA queue pair.

In some implementations, the state information 125 also includes information that is provided in a RDMA work request that is stored in an application work request queue (e.g., work request queue 151, 153, 155), such as, for example, a virtual address and length that identifies an application buffer allocated for the RDMA transmission. In some implementations, the state information includes transmission state information, such as, for example, ACK timer information, transmission signaling journals, ACK message reception information, and information identifying outstanding RDMA operations.

The operating system 112 translates a virtual address for any application buffer allocated for the RDMA transmission into a physical address, and provides RDMA transmission information to the RDMA network communication adapter device 111 in the form of a kernel work request. An application buffer specified in the kernel work request is identified by the translated physical address. The RDMA network communication adapter device 111 performs state-independent processing for the RDMA transmission, such as, for example, RDMA access responsive to the physical address, RDMA message segmentation, ICRC calculation, and ICRC validation. The operating system 112 performs state-dependant processing for the RDMA transmission, such as, for example, journaling of signaled work requests, management of ACK timers, management of NAK timers, management of connection information, processing of RDMA Read responses, processing of ACK messages. In some implementations, the operating system 112 generates packet headers for the RDMA transmission.

In the example implementation, the RDMA transmission is performed without performing an INFINIBAND memory region registration, the RDMA network communication adapter device 111 does not store a virtual address translation table, the network communication adapter device 111 does not translate the virtual address into the physical address, and pages corresponding to the application buffer are not locked prior to the RDMA transmission.

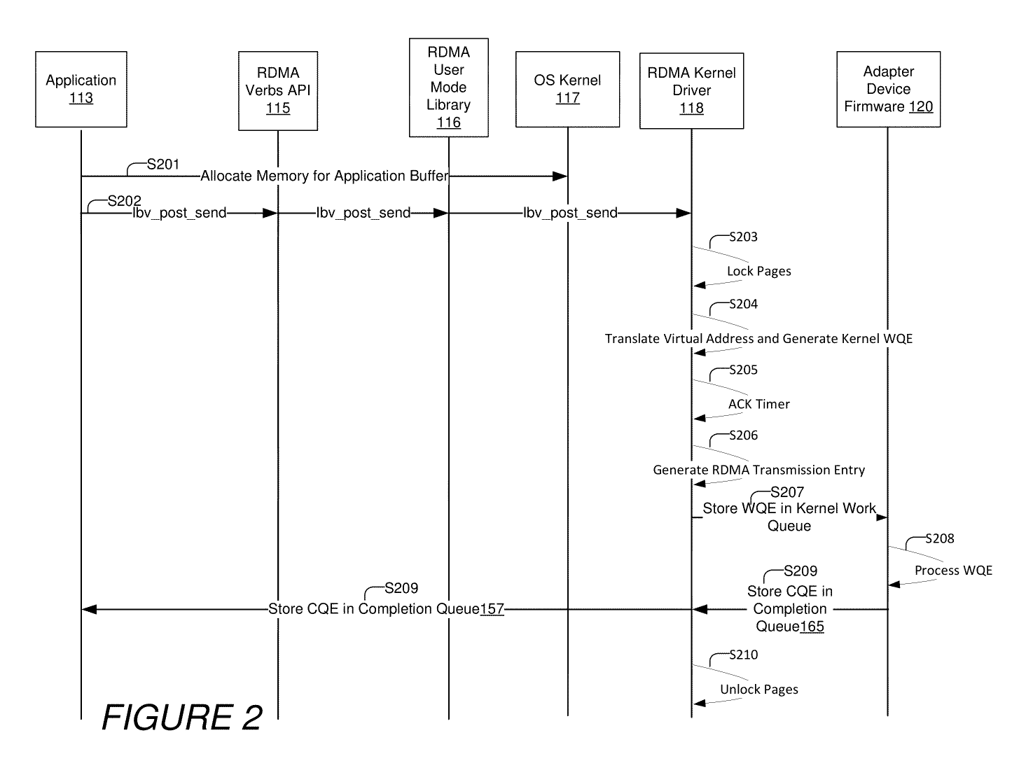

FIG. 2 is a diagram depicting an RDMA transmission between the layers of hardware, software, and/or firmware of the RDMA transceiving system 100 and the RDMA network communication adapter device 111.

At process S201, the application 113 invokes an OS system call to allocate memory in the main memory 122 for an application buffer in the application address space 130. The application 113 invokes the memory allocation system call by using the operating system (OS) application programming interface (API) 114. For example, for a transmission for a send operation, the application 113 allocates memory for a send buffer (e.g., send buffer 131). For a transmission for an RDMA write operation, the application 113 allocates memory for a write buffer (e.g., write buffer 132). For a transmission for an RDMA Read operation, the application 113 allocates memory for a read buffer (e.g., read buffer 133). In response to the memory allocation system call, the OS kernel 117 of the operating system 112 allocates the memory in the application address space 130.

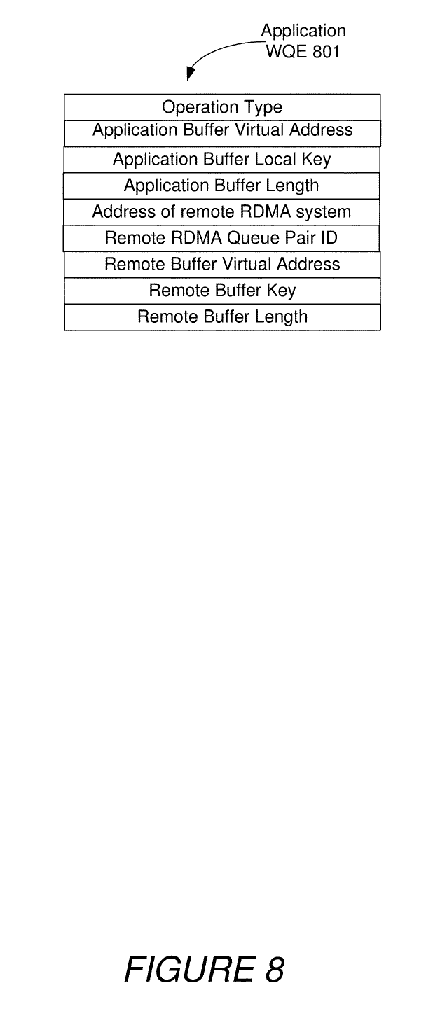

At process 5202, the application 113 generates an application work request that specifies at least an operation type (e.g., Send, RDMA Write, RDMA Read), a virtual address, local key and length that identifies the application buffer allocated at the process S201, an address of the remote RDMA node, an RDMA queue pair ID for the remote RDMA queue pair, and a virtual address, remote key and length of a buffer of a memory of the remote RDMA node. FIG. 8 is a diagram depicting an exemplary structure 801 of an application work request element.

In some implementations, the application work request specifies an RDMA partition key. In some implementations, the remote RDMA QP ID and the remote node are specified during creation of the application work queue to be used for the transmission, and they are not passed as part of the application work request.

The application 113 uses the RDMA Verbs API 115 to post the application work request to an application work queue (e.g., work queue 151, 153, 155). In the example implementation, the application 113 posts the application work request to the application work queue by using a Post Send verb provided by the RDMA Verbs API 115, and the RDMA Verbs API 115 uses the user-mode library 116, and the operating system 112, to process the Post Send verb request. In more detail, the RDMA user mode library 116 stores the application work request in the application work queue and triggers an interrupt to notify the RDMA kernel driver 118 that the application work request is in the application work queue, waiting to be processed. Responsive to the interrupt, the RDMA kernel driver 118 retrieves the application work request from the application work request queue and processes the application work request.

At process S203, the kernel driver 118 identifies that virtual address, local key and length that identifies the application buffer from the application work request, and locks pages of the main memory 122 that correspond to the application buffer. If these pages have already been locked in connection with another RDMA transmission, then the kernel driver 118 increments a reference count (stored in the state information 125) for the locked pages.

At process S204, the kernel driver 118 translates the virtual address of the application buffer into one or more physical addresses by using the OS kernel 117. The kernel driver 118 generates a kernel work queue element (WQE) based on the posted work request.

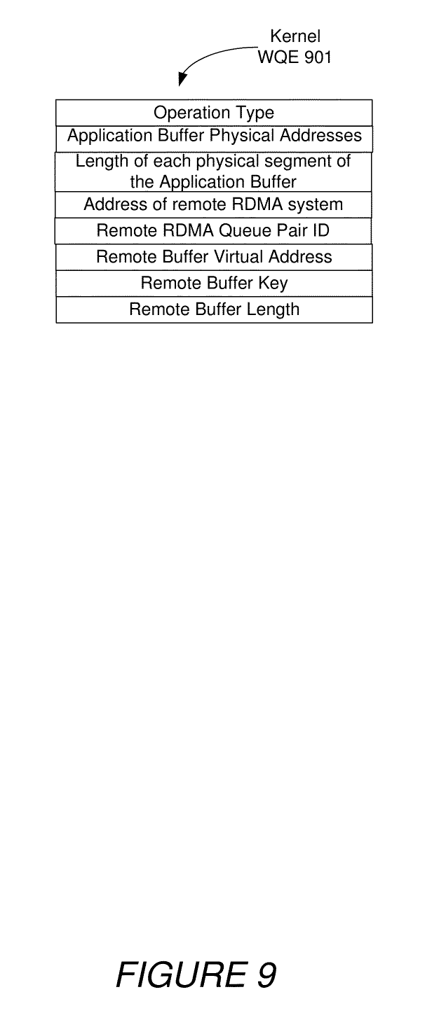

The kernel WQE specifies the operation type (e.g., Send, RDMA Write, RDMA Read), the translated physical addresses of the application buffer, length of each such physical segment of the application buffer, the address of the remote RDMA node, the RDMA queue pair ID for the remote RDMA queue pair, and the virtual address, remote key and length of the buffer of the memory of the remote RDMA node. FIG. 9 is a diagram depicting an exemplary structure 901 of a kernel work request element. In some implementations, the kernel work request specifies an RDMA partition key

In some implementations, the kernel work request includes information that is used to generate one or more of L2 and L3 packet headers of a packet of the RDMA transmission. In some implementations, the network communication adapter device 111 stores information that is used to generate one or more of L2 and L3 packet headers of a packet of the RDMA transmission.

At process S205 of FIG. 2, the kernel driver 118 starts an ACK timer that is used to determine if the RDMA transmission needs to be re-transmitted.

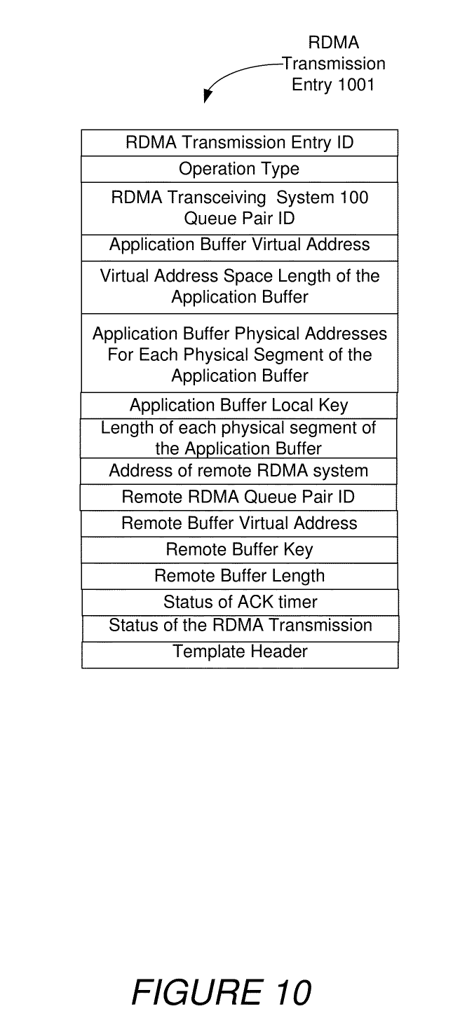

At process S206, the kernel driver 118 generates an RDMA transmission entry for the RDMA transmission, and stores the RDMA transmission entry in the state information 125 to indicate that the RDMA transmission is being processed. In an implementation, the RDMA transmission entry specifies an RDMA transmission identifier that identifies the RDMA transmission, the operation type (e.g., Send, RDMA Write, RDMA Read), the RDMA queue pair ID for the transmitting queue pair of the RDMA transceiving system 100, the virtual address of the application buffer, the local key and virtual address space length of the application buffer, application buffer physical addresses, length of each physical segment of the application buffer, the address of the remote RDMA node, the RDMA queue pair ID for the remote RDMA queue pair, and the virtual address, remote key and length of the buffer of the memory of the remote RDMA node, information indicating a status of the ACK timer, status information indicating a status of the RDMA transmission, and a template header that includes information used to generate one or more of L2 and L3 packet headers of a packet of the RDMA transmission. FIG. 10 is a diagram depicting an exemplary structure of an RDMA transmission entry. The kernel driver 118 generates the RDMA transmission entry such that the information indicating a status of the ACK timer indicates the start time of the ACK timer, and such that the status information indicates that the kernel driver 118 is awaiting reception of an ACK from the remote RDMA system for the RDMA transmission.

At process S207, the kernel driver 118 stores the kernel WQE in a kernel work queue (e.g., one of work queues 161 and 163) and triggers an adapter device interrupt to notify the firmware 120 of the network communication adapter device 111 that the kernel WQE is in the kernel work queue, waiting to be processed. After triggering the adapter device interrupt, the kernel driver 118 polls the completion queue (CQ) 165 to determine when the WQE has been processed by the network communication adapter device 111.

At process S208, responsive to the adapter device interrupt, the firmware 120 retrieves the kernel WQE from the kernel work request queue (e.g., one of work queues 161 and 163) and processes the kernel WQE. In some cases where the kernel WQE corresponds to an application work request queue that is configured for reliable connection (RC) transmission, the network communication adapter device 111 provides hardware acceleration by adding the L2 and L3 packet headers based on header information stored in the network device memory 170. For a SEND or RDMA Write operation in which the application buffer contains payload data, the firmware 120 processes the kernel WQE by retrieving the payload data stored in the application buffer, and performing RDMA message segmentation to generate a series of packets to transmit the payload data.

At process S209, after processing the kernel WQE, the firmware 120 generates a completion queue element (CQE) that indicates that the WQE has been processed by the network communication adapter device 111, and stores the CQE in the CQ 165. In the example implementation, the CQE specifies the start and end PSN (Packet Sequence Number) of each of the transmitted packets. Responsive to detection of the CQE during the polling process, the kernel driver 118 determines that the RDMA transmission has completed. Responsive to the determination that the RDMA transmission has completed, the kernel driver 118 creates and stores a CQE in a format expected by the RDMA user mode library 116 in the completion queue 157. The application 113, which polls the completion queue 157, determines that the transmission has completed.

In the example implementation, to later determine whether the kernel driver 118 has received all RDMA ACK messages corresponding to a Send or RDMA Write operation, the kernel driver 118 stores each PSN specified by the CQE in the corresponding RDMA transmission entry in the state information 125.

In the case of a Send or RDMA write operation, the kernel driver 118 determines whether to unlock the pages that are locked at the process S203. If the reference count for the pages is greater than one, meaning that the pages are used in connection with another RDMA transmission, then the kernel driver 118 decrements the reference count for the locked pages. If the reference count for the pages is one, meaning that the pages are not used in connection with another RDMA transmission, then the kernel driver 118 unlocks the pages at process S210.

In some implementations, in connection with a Send or RDMA write operation, rather than unlock the pages in response to a determination that the reference count is one, the kernel driver 118 waits until it has received all ACK messages corresponding to the RDMA transmission before unlocking the pages. In the case where the ACK timer (started in the process S205) expires before the kernel driver 118 receives all ACK messages for the RDMA transmission, the kernel driver 118 effects re-transmission of the RDMA transmission by storing the kernel WQE (generated at the process S204) in the kernel work queue and triggering an adapter device interrupt to notify the firmware 120 of the network communication adapter device 111 that the kernel WQE is in the kernel work queue, waiting to be processed. After triggering the adapter device interrupt, the kernel driver 118 polls the completion queue (CQ) 165 to determine when the WQE has been processed by the network communication adapter device 111, and waits for reception of ACK messages corresponding to the RDMA re-transmission.

More specifically, in the example implementation, the kernel driver 118 polls one or more kernel receive queues (e.g., one of kernel receive queues 162 and 164) to determine whether the network communication adapter device has received an RDMA ACK. In the example implementation, the network communication adapter device stores all received RDMA ACK messages on one or more of the kernel receive queues (e.g., one of kernel receive queues 162 and 164). In polling the kernel receive queues, the kernel driver 118 accesses the information stored in the kernel receive queues and determines whether the stored information includes any RDMA ACK messages, which are identified based on packet headers and packet structure. In response to a determination that a polled kernel receive queue stores an RDMA ACK message, the kernel driver 118 compares a PSN included in a header of the RDMA ACK message with PSNs that are stored in the corresponding RDMA transmission entry included in the state information 125. In a case where the kernel driver 118 identifies an RDMA ACK message for each PSN that is stored in the RDMA transmission entry, the kernel driver 118 determines that it has received all RDMA ACK messages corresponding to the RDMA transmission and therefore it unlocks the pages that are locked at the process S203.

In the example implementation, the kernel driver 118 also polls the NIC receive queue 141 to determine whether the network communication adapter device has received an RDMA Read Response message. In some implementations, the kernel driver 118 does not need to poll the NIC receive queue 141 to determine whether the network communication adapter device has received an RDMA Read Response message. In these cases, an interrupt may be used in the alternative.

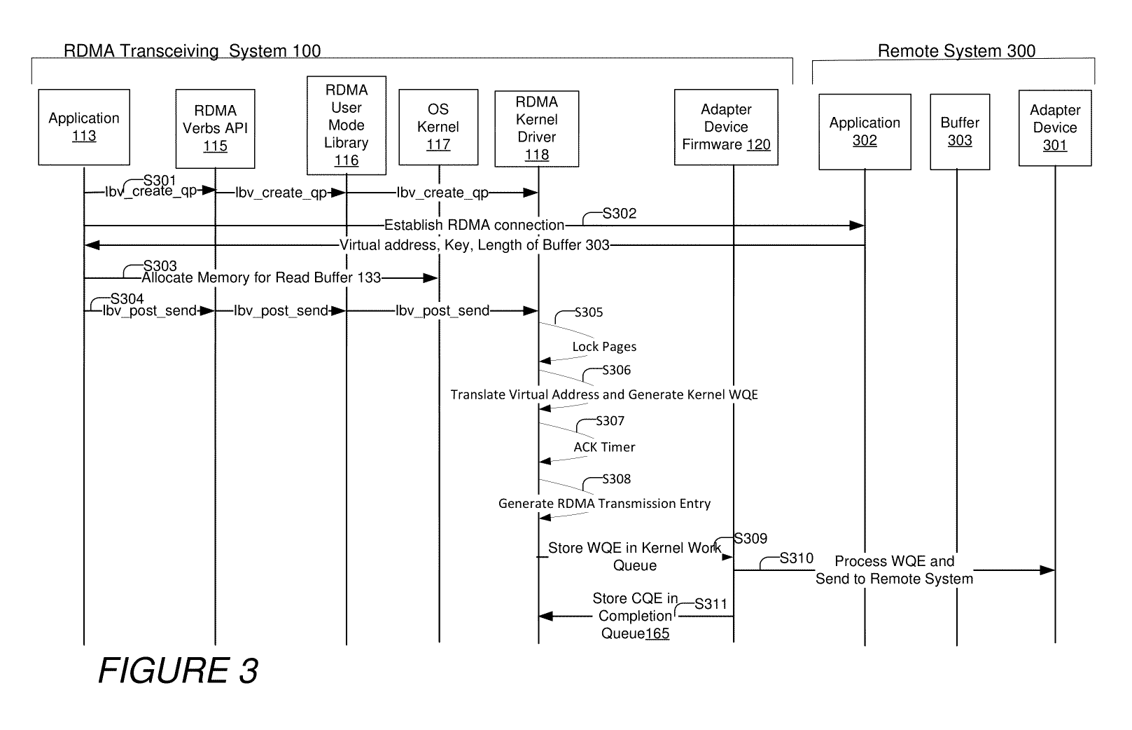

FIG. 3 is a diagram depicting an RDMA transmission for an RDMA Read operation.

At process S301, the application 113 of the RDMA transceiving system 100 creates a RDMA queue pair by invoking the Create Queue Pair RDMA verb. As a result of invoking the Create Queue Pair RDMA verb, the application 113 receives a queue pair ID for the created queue pair from the kernel driver 118. The created queue pair includes the application work queue 151 and the application receive queue 152.

At process S302, the application 113 communicates with an application 302 of a remote RDMA system 300 to establish an RDMA connection between the application work queue 151 and the application receive queue 152 of the RDMA transceiving system 100 with an RDMA work queue and an RDMA receive queue of the remote RDMA system 300. In establishing the connection, the application 113 receives a virtual address, remote key, and length of a remote buffer 303 in an application address space of the remote system 300. The remote buffer 303 stores data to be read by the RDMA transceiving system 100 in connection with an RDMA Read operation.

At process 5303, the application 113 invokes an OS system call to allocate memory in the main memory 122 for the read buffer 133 in the application address space 130. The application 113 invokes the memory allocation system call by using the operating system (OS) application programming interface (API) 114. In response to the memory allocation system call, the OS kernel 117 of the operating system 112 allocates the memory in the application address space 130.

At process 5304, the application 113 generates an application work request (e.g., a request for an RDMA transmission) that specifies a RDMA Read operation type, a virtual address, local key and length that identifies the read buffer 133, an address of the remote RDMA system 300, an RDMA queue pair ID for the remote RDMA queue pair that includes the RDMA work queue and the RDMA receive queue of the remote system 300, and the virtual address, remote key and length of the remote buffer 303. The application 113 uses the RDMA Verbs API 115 to post the application work request to the application work queue 151. In the example implementation, the application 113 posts the application work request to the application work queue 151 queue by using a Post Send verb provided by the RDMA Verbs API 115, and the RDMA Verbs API 115 uses the user-mode library 116, and the operating system 112 to process the Post Send verb request. In more detail, the RDMA user mode library 116 stores the application work request in the application work queue 151 and triggers an interrupt to notify the RDMA kernel driver 118 that the application work request is in the application work queue 151, waiting to be processed. Responsive to the interrupt, the RDMA kernel driver 118 retrieves the application work request from the application work request queue 151 and processes the application work request.

At process 5305, the kernel driver 118 determines whether the length of the remote buffer 303 is less than a threshold size. IN a case where the kernel driver determines that the length of the remote buffer 303 is not less than the threshold size, the kernel driver 118 identifies that virtual address, local key and length that identifies the read buffer 133 from the application work request, and locks pages of the main memory 122 that correspond to the read buffer 133. If these pages have already been locked in connection with another RDMA transmission, then the kernel driver 118 increments a reference count for the locked pages. In a case where the kernel driver 118 determines that the length of the read buffer 303 is less than the threshold size, the kernel driver 118 does not lock the pages of the main memory 122 that correspond to the read buffer 133. In an implementation, in the case where the kernel driver 118 determines that the length of the read buffer 303 is less than the threshold size, when the read response arrives, it is copied to a virtual address being given. In such case, the kernel 118 relies on the normal operating system paging system to perform the memory translation. In the example embodiment, the threshold size is less than a CPU cache size of at least one of the processors 101A-101N. In some implementations, the threshold is a configurable parameter that is configured based on system resources and speed, such as, for example, a CPU speed.

At process 5306, the kernel driver 118 translates the virtual address of the read buffer 133 into a physical address by using the OS kernel 117. The kernel driver 118 generates a kernel work queue element (WQE) based on the posted work request.

The kernel WQE specifies the RDMA Read operation type, the translated physical addresses of the read buffer 133, and length of the read buffer 133, the address of the remote RDMA system 300, the RDMA queue pair ID for the remote RDMA queue pair, and the virtual address, remote key and length of the remote buffer 303. In some implementations, the application work request specifies an RDMA partition key

At process 5307, the kernel driver 118 starts an ACK timer that is used to determine if the RDMA transmission needs to be re-transmitted.

At process 5308, the kernel driver 118 generates an RDMA transmission entry for the RDMA transmission, and stores the RDMA transmission entry in the state information 125 to indicate that the RDMA transmission is being processed. In the example implementation, the RDMA transmission entry specifies an RDMA transmission identifier that identifies the RDMA transmission, the RDMA Read operation type, the RDMA queue pair ID for the queue pair of the RDMA transceiving system 100, a virtual address of the read buffer 133, the local key and virtual address space length of the read buffer 133, application buffer physical addresses, length of each physical segment of the application buffer, an address of the remote RDMA system 300, an RDMA queue pair ID for the remote RDMA queue pair that includes the RDMA work queue and the RDMA receive queue of the remote system 300, and the virtual address, remote key and length of the remote buffer 303, information indicating a status of the ACK timer, and status information indicating a status of the RDMA transmission, and a template header that includes information used to generate one or more of L2 and L3 packet headers of a packet of the RDMA transmission. The kernel driver 118 generates the RDMA transmission entry such that the entry indicates a status of the ACK timer, indicates a start time of the ACK timer, and indicates that the kernel driver 118 is awaiting reception of an ACK from the remote RDMA system 300 for the RDMA transmission of the RDMA Read operation. The RDMA queue pair ID for the queue pair of the RDMA transceiving system 100 is the queue pair ID that is generated by the kernel driver 118 in response to processing the Create Queue Pair RDMA verb at process S301.

At process S309, the kernel driver 118 stores the kernel WQE in a kernel work queue 161 and triggers an interrupt to notify the firmware 120 of the network communication adapter device 111 that the kernel WQE is in the kernel work queue 161, waiting to be processed. After triggering the adapter device interrupt, the kernel driver 118 polls the completion queue (CQ) 165 to determine when the WQE has been processed by the network communication adapter device 111.

At process S310, responsive to the adapter device interrupt, the firmware 120 retrieves the kernel WQE from the kernel work request queue 161 and processes the kernel WQE by sending an RDMA Read message to the network communication adapter device 301 of the remote system 300. In a case where the kernel WQE corresponds to an application work request queue that is configured for reliable connection (RC) transmission, the network communication adapter device 111 provides hardware acceleration by adding the L2 and L3 packet headers based on header information stored in the network device memory 170.

At process S311, after processing the kernel WQE, the firmware 120 generates a completion queue element (CQE) that indicates that the WQE has been processed by the network communication adapter device 111, and stores the CQE in the CQ 165. Responsive to detection of the CQE during the polling process, the kernel driver 118 determines that the RDMA transmission has completed. The application 113 polls the completion queue 157 for a CQE (completion queue entry) indicating completion of the RDMA Read operation.

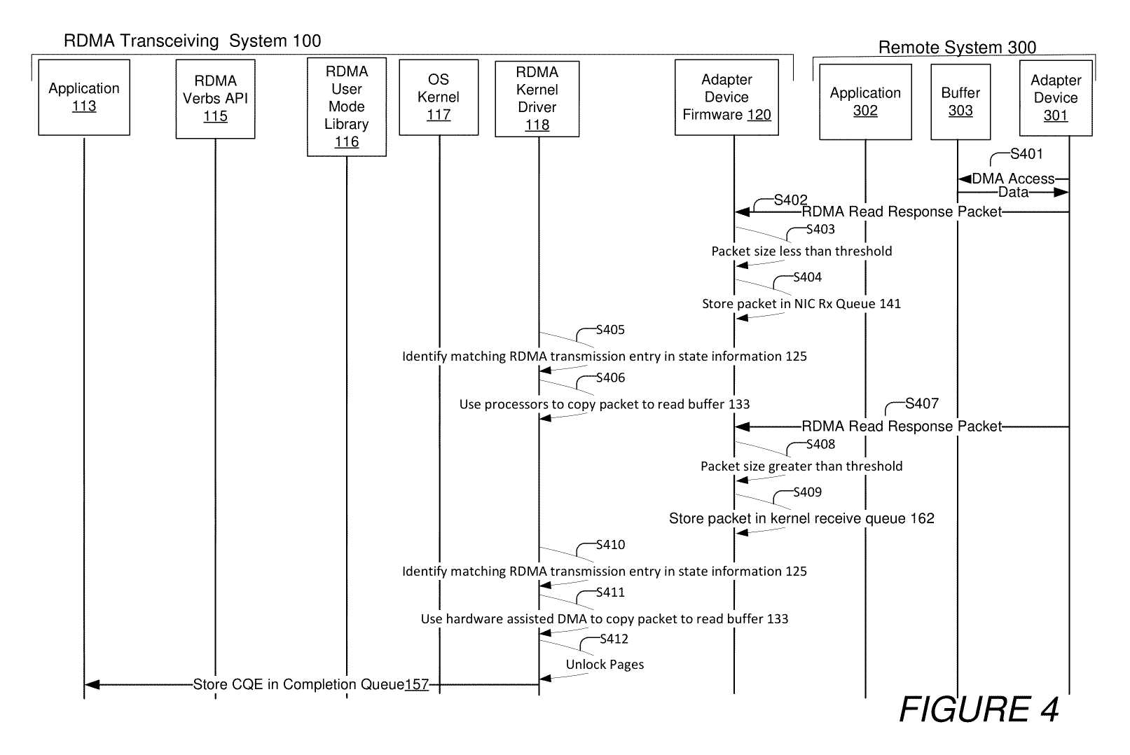

FIG. 4 is a diagram depicting a processing of a read response for an RDMA Read operation.

At process S401, responsive to receiving the RDMA Read message from the RDMA transceiving system 100, the a RDM-enabled network communication adapter device 301 of the remote system 300 identifies the virtual address, remote key and length of the remote buffer 303 from received packets corresponding to the received RDMA Read message. The RDMA-enabled network communication adapter device 301 performs a DMA access to read data stored in the remote buffer 303, and generates an RDMA Read Response message that includes the data read from the remote buffer 303. The RDM-enabled network communication adapter device 301 segments the RDMA Read Response message into a series of RDMA Read Response packets.

At process S402, the remote system 300 sends a first RDMA Read response packet to the RDMA transceiving system 100.

At process S403, the network communication adapter device 111 receives the first RDMA Read response packet and determines whether a size of the packet is greater than a predetermined threshold size. In the example embodiment, the threshold size is less than a CPU cache size of at least one of the processors 101A-101N. The network communication adapter device 111 determines that the size of the first RDMA Read response packet is less than the predetermined threshold size. In some implementations, the threshold is a configurable parameter that is configured based on system resources and speed, such as, for example, a CPU speed.

At the process S404, because the network communication adapter device 111 determines that the size of the first RDMA Read response packet is less than the threshold size, the network communication adapter device 111 stores the first RDMA Read response packet in the NIC receive queue 141.

In the example implementation, at process S405, the kernel driver 118 determines from the polling of the NIC receive queue 141 that the network communication adapter device 111 has stored a packet on the NIC receive queue 141, and determines from the packet headers and packet structure of the stored first RDMA Read Response packet that the packet is an RDMA Read Response packet. The kernel driver 118 identifies the RDMA operation type and destination queue pair ID specified in the RDMA Read Response packet headers, and searches for a RDMA transmission entry in the state information 125 whose operation type matches the operation type of the RDMA Read Response packet, whose RDMA queue pair ID (for the queue pair of the RDMA transceiving system 100) matches the destination queue pair ID of the RDMA Read Response packet, and whose status information indicates that the kernel driver 118 is awaiting an RDMA Read Response for the associated transaction.

At process S406, responsive to identifying a matching RDMA transmission entry in the state information 125, the kernel driver 118 identifies the virtual address, the local key, and the length of the read buffer 133 that are specified in the matching RDMA transmission entry. The kernel driver 118 controls at least one of the processors 101A-101N to copy the first RDMA Read response packet from the NIC receive queue 141 to the read buffer 133 responsive to identifying the virtual address, the local key, and the length of the read buffer 133. In some implementations, the kernel driver 118 uses a processor cache bypass interface in which copying data from a source to a destination does not get cached in the data TLB or any one of the L1 or the L2 cache of the processor. By virtue of using such a processor bypass interface, cache pollution may be reduced during a data copy operation.

At process S407, the remote system 300 sends a second RDMA Read response packet to the RDMA transceiving system 100.

At process S408, the network communication adapter device 111 receives the second RDMA Read response packet and determines that the size of the second RDMA Read response packet is greater than the predetermined threshold size.

At the process S409, because the network communication adapter device 111 determines that the size of the second RDMA Read response packet is greater than the threshold size, the network communication adapter device 111 stores the second RDMA Read response packet in one of the kernel receive queues (e.g., one of the kernel receive queues 162 and 164). In the example implementation, the network communication adapter device 111 removes the L2 and L3 headers (but keeps the transport layer headers) from the second RDMA Read response packet before storing the second RDMA Read response packet in one of the kernel receive queues. In some implementations, the network communication adapter device 111 does not remove the L2 and L3 headers from the second RDMA Read response packet before storing the second RDMA Read response packet in one of the kernel receive queues.

In the example implementation, at process S410, the kernel driver 118 determines from the polling of kernel receive queue 162 that the network communication adapter device 111 has stored a packet on the kernel receive queue 162, and determines from the packet headers and packet structure of the stored second RDMA Read Response packet that the packet is an RDMA Read Response packet. The kernel driver 118 identifies the RDMA operation type and destination queue pair ID specified in the RDMA Read Response packet headers, and searches for a RDMA transmission entry in the state information 125 whose operation type matches the operation type of the second RDMA Read Response packet, whose RDMA queue pair ID (for the queue pair of the RDMA transceiving system 100) matches the destination queue pair ID of the second RDMA Read Response packet, and whose status information indicates that the kernel driver 118 is awaiting an RDMA Read Response for the associated transaction.

At process 5411, responsive to identifying a matching RDMA transmission entry in the state information 125, the kernel driver 118 identifies the virtual address, the and the length of the read buffer 133 that are specified in the matching RDMA transmission entry.

In the example implementation, the kernel driver 118 performs a hardware assisted DMA operation to copy the second RDMA Read response packet from the kernel receive queue 162 to the read buffer 133, responsive to identifying the virtual address, the local key, and the length of the read buffer 133. In the example implementation, the kernel driver 118 determines whether an I/OAT (I/O Acceleration Technology) DMA interface is available. If an I/OAT interface is available, then the kernel driver uses the I/OAT interface to perform the hardware assisted DMA operation to copy the second RDMA Read response packet from the kernel receive queue 162 to the read buffer 133.

If an I/OAT interface is not available, the kernel driver 118 uses a DMA interface provided by the network communication adapter device 111 to perform the hardware assisted DMA operation to copy the second RDMA Read response packet from the kernel receive queue 162 to the read buffer 133. More specifically, the kernel driver 118 converts virtual addresses of the kernel receive queue 162 and the read buffer into physical addresses. The kernel driver 118 generates a hardware assisted DMA copy request that specifies the physical address of the kernel receive queue 162 as the input buffer and specifies the physical address of the read buffer 133 as an output buffer. The kernel driver 118 provides the hardware assisted DMA copy request to the network communication adapter device 111 via the adapter's DMA interface. The kernel driver 118 polls the completion queue 165 for an indication that the DMA copy has completed. Responsive to reception of the DMA copy request, the network communication adapter device 111 performs the DMA copy from the kernel receive queue 162 to the read buffer 133. After completing the DMA copy, the network communication adapter device 111 stores a unique handle that indicates completion of the DMA copy in the completion queue 165, and triggers an interrupt to notify the RDMA kernel driver 118 that the completion handle is in the completion queue 165. In some implementations one or more of the OS kernel 117 and the kernel driver 118 uses one or more of an I/OAT interface and a DMA copy request interface of the adapter device 111 based on one or more of statistics, heuristics, outstanding requests to the OS kernel 117, outstanding request to the kernel driver 117, and CPU utilization heuristics.

In some implementations, the network communication adapter device 111 stores the unique handle that indicates completion of the DMA copy in a completion queue (not shown) that is dedicated to hardware assisted DMA copy requests that are received via the adapter's DMA interface.

At process 5412, after all read response packets are received, the kernel driver 118 unlocks pages for the read buffer 133, and generates a CQE (completion queue entry) indicating completion of the RDMA Read operation as expected by the application 113. In some implementations, the kernel driver 118 ensures that WQE (work queue element) completion ordering is guaranteed as expected by the application 113. The kernel driver 118 stores the generated CQE in the completion queue 157. The application 113, which polls the completion queue 157, determines that the RDMA Read operation has completed.

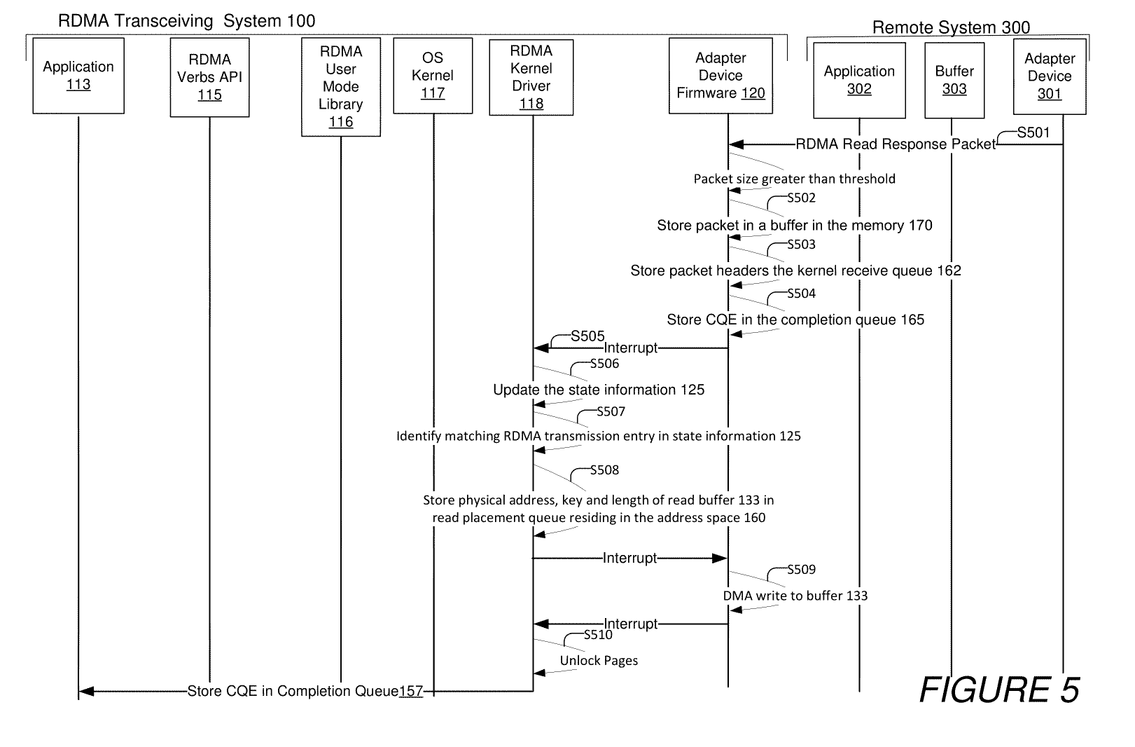

FIG. 5 is a diagram depicting a processing of a read response for an RDMA Read operation in accordance with an implementation in which the network communication adapter device 111 has RDMA Read response buffers in the adapter device memory 170.

At process 5501, the firmware 120 of the network communication adapter device 111 receives an RDMA Read Response packet, identifies the packet as an RDMA Read response packet based on the packet headers and packet structure, and determines that the size of the RDMA Read response packet is greater than the predetermine threshold size.

At process S502, because the network communication adapter device 111 determines that the size of the RDMA Read response packet is greater than the threshold size, the network communication adapter device 111 stores the RDMA Read response packet in a read response buffer in the adapter device memory 170.

At the process S503, the network communication adapter device 111 stores header information of the RDMA Read response packet in a kernel receive queue (e.g., one of the kernel receive queues 162 and 164).

At process S504, the network communication adapter device 111 generates a completion queue entry (CQE) that includes a buffer identifier for the buffer that stores the RDMA Read response packet. The network communication adapter device 111 stores the CQE in the completion queue 165.

At process S505, the network communication adapter device 111 triggers an interrupt to pass the buffer identifier to the kernel driver 118 and notify the kernel driver 118 that header information for the RDMA Read response packet is stored on the kernel receive queue, and the buffer CQE containing the buffer identifier is stored on the completion queue 165.

At process S506, responsive to the interrupt, the kernel driver 118 updates the state information 125 to indicate that the adapter device buffer that is identified by the buffer identifier included in the CQE contains read response data. The kernel driver 118 records the state of the adapter device buffers (e.g., whether they contain data or not) and compares the state of the adapter device buffers with the RDMA transaction entries (stored in the state information 125) to determine whether there is sufficient buffer space in the network communication adapter device 111 for outstanding RDMA Read operations. Using this state information, the kernel driver 118 controls the network communication adapter device 111 to ensure that adapter device buffers do not overflow.

At process S507, the kernel driver 118 retrieves the header information from the kernel receive queue, and identifies the RDMA operation type and destination queue pair ID specified in the RDMA Read Response packet header information. The kernel driver 118 searches for a RDMA transmission entry in the state information 125 whose operation type matches the operation type of the RDMA Read Response header information, whose RDMA queue pair ID (for the queue pair of the RDMA transceiving system 100) matches the destination queue pair ID of the RDMA Read Response header information, and whose status information indicates that the kernel driver 118 is awaiting an RDMA Read Response for the associated transaction.

Responsive to identifying a matching RDMA transmission entry in the state information, the kernel driver 118 identifies the virtual address, the local key, and the length of the read buffer 133 that are specified in the matching RDMA transmission entry.

At process S508, the kernel driver 118 translates the virtual address of the read buffer 133 into a physical address, and stores the translated physical address, the local key, and the length of the read buffer 133 in a dedicated read placement queue that resides in the kernel queue address space 160 of the main memory 122. The kernel driver 118 triggers an interrupt to notify the network communication adapter device 111 that the physical address, key and length of the read buffer 133 are stored on the read placement queue.

At process S509, responsive to the interrupt, the network communication adapter device 111 retrieves the physical address, key and length of the read buffer 133 from the read placement queue and performs a DMA operation to write the data from the network communication adapter device 111 buffer to the read buffer 133.

At process S510, the network communication adapter device 111 notifies the kernel driver 118 that the DMA operation has completed, and responsive to the notification, the kernel driver 118 unlocks pages of the read buffer 133, and generates a CQE (completion queue entry) indicating completion of the RDMA Read operation as expected by the application 113. In some implementations, the kernel driver 118 ensures that WQE (work queue element) completion ordering is guaranteed as expected by the application 113. The kernel driver 118 stores the generated CQE in the completion queue 157. The application 113, which polls the completion queue 157, determines that the RDMA Read operation has completed.

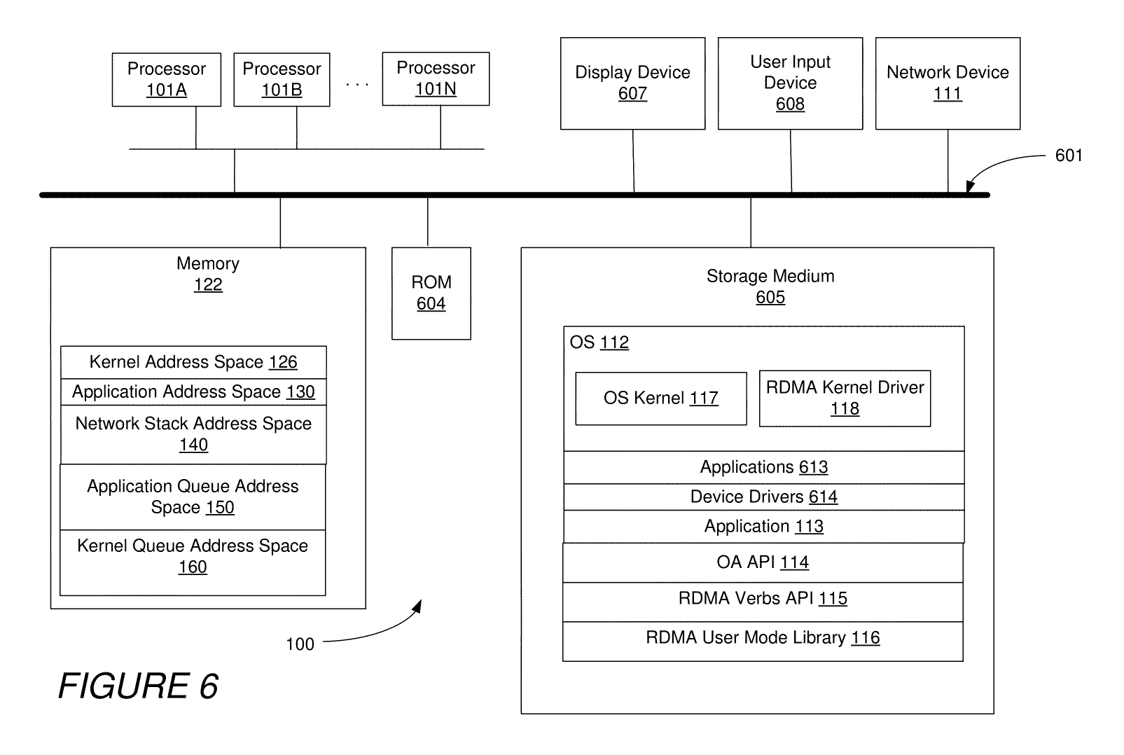

FIG. 6 is an architecture diagram of the RDMA transceiving system 100. In the example embodiment, the RDMA transceiving system 100 is a server device.

The bus 601 interfaces with the processors 101A-101N, the main memory (e.g., a random access memory (RAM)) 122, a read only memory (ROM) 604, a processor-readable storage medium 605, a display device 607, a user input device 608, and the network communication adapter device 111 of FIG. 1B.

The processors 101A-101N may take many forms, such as ARM processors, X86 processors, and the like.

In some implementations, the operating node includes at least one of a central processing unit (processor) and a multi-processor unit (MPU).

The network device 111 provides one or more wired or wireless interfaces for exchanging data and commands between the RDMA transceiving system 100 and other devices, such as a remote RDMA system. Such wired and wireless interfaces include, for example, a Universal Serial Bus (USB) interface, Bluetooth interface, Wi-Fi interface, Ethernet interface, Near Field Communication (NFC) interface, and the like.

Machine-executable instructions in software programs (such as an operating system 112, application programs 613, and device drivers 614) are loaded into the memory 122 from the processor-readable storage medium 605, the ROM 604 or any other storage location. During execution of these software programs, the respective machine-executable instructions are accessed by at least one of processors 101A-101N via the bus 601, and then executed by at least one of processors 101A-101N. Data used by the software programs are also stored in the memory 122, and such data is accessed by at least one of processors 101A-101N during execution of the machine-executable instructions of the software programs.

The processor-readable storage medium 605 is one of (or a combination of two or more of) a hard drive, a flash drive, a DVD, a CD, a flash storage, a solid state drive, a ROM, an EEPROM and the like. The processor-readable storage medium 605 includes software programs 613, device drivers 614, and the operating system 112, the application 113, the OS API 114, the RDMA Verbs API 115, and the RDMA user mode library 116 of FIG. 1B. The OS 112 includes the OS kernel 117 and the RDMA kernel driver 118 of FIG. 1B.

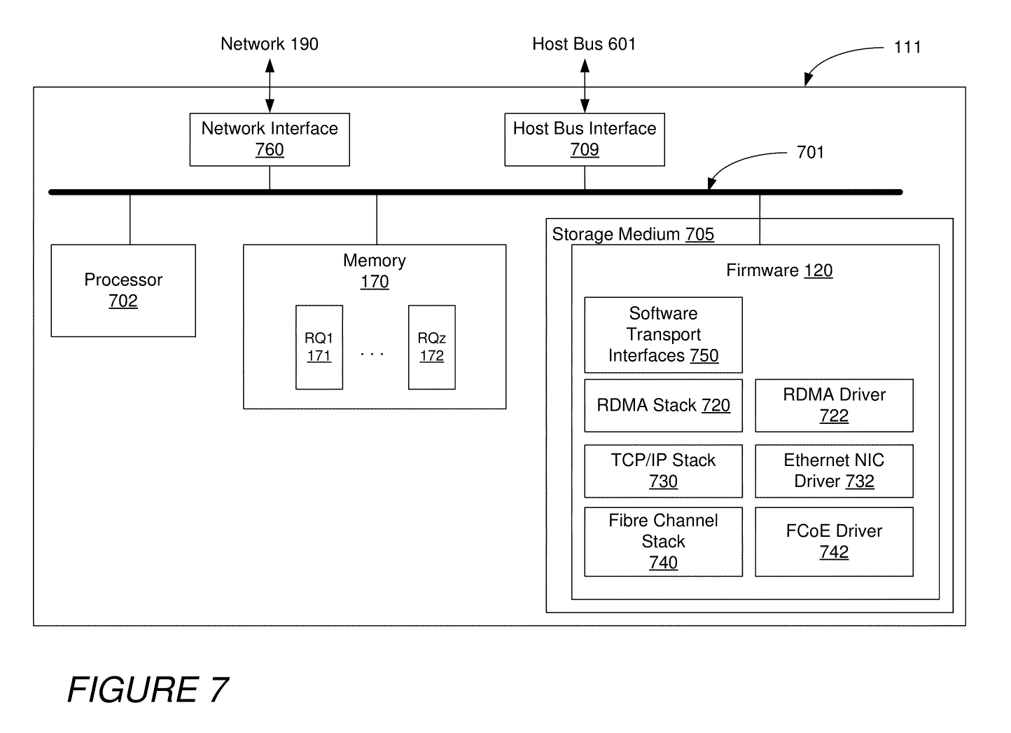

FIG. 7 is an architecture diagram of the RDMA network communication adapter device 111 of the RDMA transceiving system 100.

In the example embodiment, the RDMA network communication adapter device 111 is a network communication adapter device that is constructed to be included in a server device. In some embodiments, the RDMA network communication adapter device is a network communication adapter device that is constructed to be included in one or more of different types of RDMA transceiving systems, such as, for example, client devices, network devices, mobile devices, smart appliances, wearable devices, medical devices, sensor devices, vehicles, and the like.

The bus 701 interfaces with a processor 702, a random access memory (RAM) 170, a processor-readable storage medium 705, a host bus interface 709 and a network interface 760.

The processor 702 may take many forms, such as, for example, a central processing unit (processor), a multi-processor unit (MPU), an ARM processor, and the like.

The network interface 760 provides one or more wired or wireless interfaces for exchanging data and commands between the network communication adapter device 111 and other devices, such as, for example, another network communication adapter device. Such wired and wireless interfaces include, for example, a Universal Serial Bus (USB) interface, Bluetooth interface, Wi-Fi interface, Ethernet interface, Near Field Communication (NFC) interface, and the like.

The host bus interface 709 provides one or more wired or wireless interfaces for exchanging data and commands via the host bus 601 of the RDMA transceiving system 100. In the example implementation, the host bus interface 709 is a PCIe host bus interface.

Machine-executable instructions in software programs are loaded into the memory 170 from the processor-readable storage medium 705, or any other storage location. During execution of these software programs, the respective machine-executable instructions are accessed by the processor 702 via the bus 701, and then executed by the processor 702. Data used by the software programs are also stored in the memory 170, and such data is accessed by the processor 702 during execution of the machine-executable instructions of the software programs.

The processor-readable storage medium 705 is one of (or a combination of two or more of) a hard drive, a flash drive, a DVD, a CD, a flash storage, a solid state drive, a ROM, an EEPROM and the like. The processor-readable storage medium 705 includes the firmware 120. The firmware 120 includes software transport interfaces 750, an RDMA stack 720, an RDMA driver 722, a TCP/IP stack 730, an Ethernet NIC driver 732, a Fibre Channel stack 740, and an FCoE (Fibre Channel over Ethernet) driver 742.

In the example implementation, the RDMA driver 722 processes initiating RDMA transmissions received from a remote device that initiate operations, such as, for example, a Send, RDMA Write or RDMA Read operation. In more detail, the RDMA driver 722 processes such received initiating RDMA transmissions in an offloaded manner such that the OS 112 and the processors 101A-101N are not involved in the processing.

The memory 170 includes the offloaded receive queues 171 and 172.

In the example implementation, RDMA verbs are implemented in software transport interfaces 750. In the example implementation, the RDMA protocol stack 720 is an INFINIBAND protocol stack. In the example implementation the RDMA stack 720 handles different protocol layers, such as the transport, network, data link and physical layers.

As shown in FIG. 7, the RDMA network communication adapter device 111 is configured with full RDMA offload capability, which means that both the RDMA protocol stack 720 and the RDMA verbs (included in the software transport interfaces 750) are implemented in the hardware of the RDMA network communication adapter device 111. As shown in FIG. 7, the RDMA network communication adapter device 111 uses the RDMA protocol stack 720, the RDMA driver 722, and the software transport interfaces 750 to provide RDMA functionality. The RDMA network communication adapter device 111 uses the Ethernet NIC driver 732 and the corresponding TCP/IP stack 730 to provide Ethernet and TCP/IP functionality. The RDMA network communication adapter device 111 uses the Fibre Channel over Ethernet (FCoE) driver 742 and the corresponding Fibre Channel stack 740 to provide Fibre Channel over Ethernet functionality.

In operation, the RDMA network communication adapter device 111 communicates with different protocol stacks through specific protocol drivers. Specifically, the RDMA network communication adapter device 111 communicates by using the RDMA stack 720 in connection with the RDMA driver 722, communicates by using the TCP/IP stack 730 in connection with the Ethernet driver 732, and communicates by using the Fibre Channel (FC) stack 740 in connection with the Fibre Channel over the Ethernet (FCoE) driver 742. As described above, RDMA verbs are implemented in the software transport interfaces 750.

While various example embodiments of the present disclosure have been described above, it should be understood that they have been presented by way of example, and not limitation. It will be apparent to persons skilled in the relevant art(s) that various changes in form and detail can be made therein. Thus, the present disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Furthermore, an Abstract is attached hereto. The purpose of the Abstract is to enable the U.S. Patent and Trademark Office and the public generally, including those who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. An information processing apparatus comprising:
a remote direct memory access (RDMA) network communication adapter device to provide remote direct memory access (RDMA) to a remote device;
at least one processor constructed to execute instructions, the at least one processor in communication with the RDMA network communication adapter device; and
at least one processor-readable storage device in communication with the at least one processor, the at least one processor-readable storage device constructed to store instructions for execution by the at least one processor, wherein the instructions stored in the at least one processor-readable storage device when executed by the at least one processor perform processes including:
responsive to a request for an RDMA transmission, performing at least a first sub-process of the RDMA transmission by using an operating system of the apparatus;
providing RDMA transmission information to the RDMA network communication adapter device, the RDMA network communication adapter device performing at least a second sub-process of the RDMA transmission responsive to the RDMA transmission information,
wherein the request for the RDMA transmission includes at least a virtual address corresponding to a buffer to be used for the RDMA transmission,
wherein the operating system translates the virtual address into a corresponding physical address of a main memory of the apparatus, and
wherein the RDMA transmission information includes the translated physical address, and the RDMA network communication adapter device performs an RDMA access responsive to the physical address.

2. The apparatus of claim 1, wherein the RDMA transmission is performed without the need to perform an INFINIBAND memory region registration, the RDMA network communication adapter device need not store a virtual address translation table, the RDMA network communication adapter device need not translate the virtual address into the physical address, and pages corresponding to the buffer are need not be locked prior to the RDMA transmission as part of a memory registration process.

3. The apparatus of claim 1, wherein the RDMA network communication adapter device processes RDMA transmissions received from a remote device.

4. The apparatus of claim 1, wherein the operating system processes RDMA Read responses.

5. The apparatus of claim 1, wherein the operating system maintains a state of the RDMA transmission, and the state of the RDMA transmission includes at least one of signaling journals and ACK timers.

6. The apparatus of claim 1, wherein the first sub-process includes at least one of journaling of signaled work requests, management of ACK timers and management of NAK timers.

7. The apparatus of claim 1, wherein the second sub-process includes at least one of message segmentation, ICRC calculation, and ICRC validation.

8. The apparatus of claim 1, wherein the buffer includes at least one of a send buffer, a write buffer, a read buffer and a receive buffer in an application address space.

9. The apparatus of claim 1,
wherein the operating system receives the request for the RDMA transmission via an application work request queue that resides in an address space of the main memory that is accessible by user-space and kernel-space processes, and
wherein the application work request queue resides in un-locked pages of the main memory.

10. The apparatus of claim 1, wherein the operating system provides the RDMA transmission information to the RDMA network communication adapter device via a kernel work request queue that resides in an address space of the main memory that is accessible by kernel-space processes and processes performed by the network communication adapter device,
wherein the network communication adapter device retrieves the RDMA transmission information from the kernel work request queue and performs the second sub-process responsive to the RDMA transmission information, such that the second sub-process is offloaded to the network communication adapter device, and
wherein the kernel work request queue resides in locked pages of the main memory.

11. The apparatus of claim 11, wherein a number of kernel work request queues resident in the main memory is less than a number of application work request queues resident in the main memory.

12. A network communication adapter device comprising:
at least one processor constructed to execute instructions; and
at least one processor-readable storage device in communication with the at least one processor, the at least one processor-readable storage device constructed to store instructions for execution by the at least one processor, wherein the instructions stored in the at least one processor-readable storage device when executed by the at least one processor perform processes including:
performing at least a second sub-process of a remote direct memory access (RDMA) transmission responsive to RDMA transmission information provided by an operating system of an RDMA transceiving system that is in communication with the network communication adapter device,
wherein the operating system performs at least a first sub-process of the RDMA transmission, responsive to a request for an RDMA transmission;
wherein the request for the RDMA transmission includes at least a virtual address corresponding to a buffer to be used for the RDMA transmission,
wherein the operating system translates the virtual address into a corresponding physical address of a main memory of the RDMA transceiving system, and
wherein the RDMA transmission information includes the translated physical address, and the network communication adapter device performs an RDMA access responsive to the physical address.

13. The network communication adapter device of claim 12,
wherein the operating system receives the request for the RDMA transmission via an application work request queue that resides in an address space of the main memory that is accessible by user-space and kernel-space processes, and
wherein the application work request queue resides in un-locked pages of the main memory.

14. The network communication adapter device of claim 13, wherein the operating system provides the RDMA transmission information to the network communication adapter device via a kernel work request queue that resides in an address space of the main memory that is accessible by kernel-space processes and processes performed by the network communication adapter device,
wherein the network communication adapter device retrieves the RDMA transmission information from the kernel work request queue and performs the second sub-process responsive to the RDMA transmission information, such that the second sub-process is offloaded to the network communication adapter device, and
wherein the kernel work request queue resides in locked pages of the main memory.

15. The network communication adapter device of claim 14, wherein a number of kernel work request queues resident in the main memory is less than a number of application work request queues resident in the main memory.

16. A method of controlling an information processing apparatus having at least one processor-readable storage device and at least one processor, the method comprising:
responsive to a request for an remote direct memory access (RDMA) transmission, performing at least a first sub-process of the RDMA transmission by using an operating system of the apparatus;
providing RDMA transmission information to a RDMA network communication adapter device of the apparatus, the RDMA network communication adapter device performing at least a second sub-process of the RDMA transmission responsive to the RDMA transmission information,
wherein the request for the RDMA transmission includes at least a virtual address corresponding to a buffer to be used for the RDMA transmission,
wherein the operating system translates the virtual address into a corresponding physical address of a main memory of the apparatus, and
wherein the RDMA transmission information includes the translated physical address, and the RDMA network communication adapter device performs an RDMA access responsive to the physical address.

17. The method of claim 16,
wherein the operating system receives the request for the RDMA transmission via an application work request queue that resides in an address space of the main memory that is accessible by user-space and kernel-space processes,
wherein the application work request queue resides in un-locked pages of the main memory,
wherein the operating system provides the RDMA transmission information to the RDMA network communication adapter device via a kernel work request queue that resides in an address space of the main memory that is accessible by kernel-space processes and processes performed by the network communication adapter device,
wherein the network communication adapter device retrieves the RDMA transmission information from the kernel work request queue and performs the second sub-process responsive to the RDMA transmission information, such that the second sub-process is offloaded to the network communication adapter device,
wherein the kernel work request queue resides in locked pages of the main memory, and
wherein a number of kernel work request queues resident in the main memory is independent from a number of application work request queues resident in the main memory.

18. The method of claim 16, further comprising:
performing at least a second sub-process of a remote direct memory access (RDMA) transmission responsive to RDMA transmission information provided by an operating system of an RDMA transceiving system that is in communication with the network communication adapter device,
wherein the operating system performs at least a first sub-process of the RDMA transmission, responsive to a request for an RDMA transmission;
wherein the request for the RDMA transmission includes at least a virtual address corresponding to a buffer to be used for the RDMA transmission,
wherein the operating system translates the virtual address into a corresponding physical address of a main memory of the RDMA transceiving system, and
wherein the RDMA transmission information includes the translated physical address, and the network communication adapter device performs an RDMA access responsive to the physical address.

19-20. (canceled)

21. The method of claim 16, further comprising:
translating the virtual address into a corresponding physical address of a main memory of the RDMA transceiving system.

22. The method of claim 16, further comprising:
retrieving RDMA transmission information from the kernel work request queue.
